(19) United States
(12) Patent Application Publication
(10) Pub. No.: US 2009/0212114 A1
(43) Pub. Date: Aug. 27, 2009

(54) Optical Imaging Alignment System and Method

(75) Inventor: Joshua Maxwell Vollmer, Liverpool, NY (US)

Correspondence Address: BOND, SCHOENECK & KING, PLLC, ONE LINCOLN CENTER, SYRACUSE, NY, 13202-1355, US

(73) Assignee: JADAK, LLC, North Syracuse, NY (US)

(21) Appl. No.: 12/035,918

(22) Filed: Feb. 22, 2008

(51) Int. Cl. G06K 7/10

(52) U.S. Cl. 235/462.41

(57) ABSTRACT

An optical imaging system including a laser alignment system for targeting and aligning optical imaging operations. The system includes a laser configured to project two intersecting lines along an axis that inersects the optical imager at the optimal imaging distance. The lines preferably extend perpendicularly to each other and are dimensioned to correspond to the length and width of the target when the optical imager is at an optical distance from the target. A user may properly align the optical imager by viewing the lines projected onto the target and adjusting the optic imager accordingly to quickly and easily ensure proper imaging of the target.

### BACKGROUND OF THE INVENTION

1. Field of the Invention

The present invention relates to automated data collection systems and, more specifically, to a system and method for properly aligning an optical imager for capturing encoded information.

2. Description of the Related Art

In the health care industries, barcode and other symbolic data encoding systems are being used to track information, control work flow, and ensure security and safety in the workplace. In older systems, relevant information was encoded into barcodes, which are essentially graphic representation of data (alpha, numeric, or both). Barcodes encode numbers and letters into different types of linear codes, two-dimensional codes, and composite codes (a combination of linear and two-dimensional codes) that are scanned by laser based device and then interpreted to reveal the encoded information. In more recent applications, referred to as digital or optical image capture, an optical device captures a digital picture of the barcode and software in the imager orients the picture and decodes the barcode contained in the picture. As a result of the development of such optical imaging systems, information may be encoded into more sophisticated graphical images, fonts, icons and symbols, such as Aztec code, in which various symbols are assigned to represent predetermined information, such as patient medical information, medical procedures, or even pharmaceutical doses. A chart containing the symbols alongside the associated data may be provided to a medical industry practitioner, who can then scan the appropriate symbols using an optical imager to rapidly and easily record the information electronically, program medical devices, etc.

While sophisticated icons and graphics may expedite the manual entry of data, many problems arise during the implementation of optical imaging systems for use in the field. For example, the space available for presentation of symbols and their associated information on user data entry pages is limited, so the symbols are often severely reduced in size and positioned in close proximity to each other to maximize the amount of information that is at the disposal of a user. As a result, the optical images used to read and recognize the symbols must be precisely aligned to properly image the symbol and improper alignment will result in ineffective recognition.

Systems for optical imaging and capturing symbol based data schemes therefore often include alignment mechanism to promote proper imaging, particular by end user. For example, some conventional systems surround the imaging unit with a clear, tubular structure that must be positioned directly over the symbol to be captured and interpreted. These systems are clumsy to operate, however, and still require that the user determine whether the tube has been properly positioned over the icon. Due to the size of the optical imaging device, it may be hard for users to easily perceive whether the device is properly aligned or to do so in an expeditious manner.

### BRIEF SUMMARY OF THE INVENTION

It is therefore a principal object and advantage of the present invention to provide a system and method for ensuring the proper alignment of optical imaging systems.

It is an additional object and advantage of the present invention to provide a system and method for improving the accuracy of optical imaging systems.

It is a further object and advantage of the present invention to provide a system and method for improving the efficiency of optical imaging systems.

In accordance with the foregoing objects and advantages, the present invention provides a laser alignment system for targeting an optical imaging system, such as a handheld optical imager communicating with a host system. More particularly, the laser alignment system comprises at least one optical laser configured to project two intersecting lines along substantially the same axis as the optical path of the optical imager. The laser is preferable configured to project lines onto a target that extend perpendicularly to each other and are dimensioned to correspond to the length and width of the target when the optical imager is at an optical distance from the target. In a preferred embodiment, the projected lines comprise four segments extending outwardly from a central point, wherein adjacent segments extend perpendicular from each other, and the target comprises a symbol enclosed by a circle. A user may verify proper alignment of the optical imager by viewing the lines projected onto the target and adjust positioning of the optical imager accordingly to quickly and easily ensure proper imaging of the target. In a preferred embodiment, a user may verify proper alignment by checking that each segment is of equal length and extends from the center of the target to the line forming the circle. If the optical imager is misaligned, the segments will not be of equal length. Similarly, if the image is positioned to closely or too remotely from the target, the projected lines will not fit precisely within the target circle.

### BRIEF DESCRIPTION OF THE DRAWINGS

The present invention will be more fully understood and appreciated by reading the following Detailed Description in conjunction with the accompanying drawings, in which:

FIG. 1 is a perspective view of an authentication control system according to the present invention.

FIG. 2 is a schematic of an authentication control system according to the present invention.

FIG. 3 is a high-level flowchart of a control process according to the present invention.

FIG. 4 is a low-level flowchart of an indicia recognition process according to the present invention.

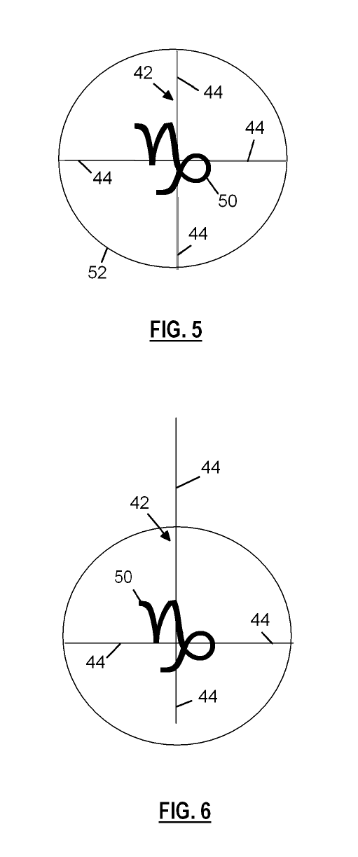

### DETAILED DESCRIPTION OF THE INVENTION

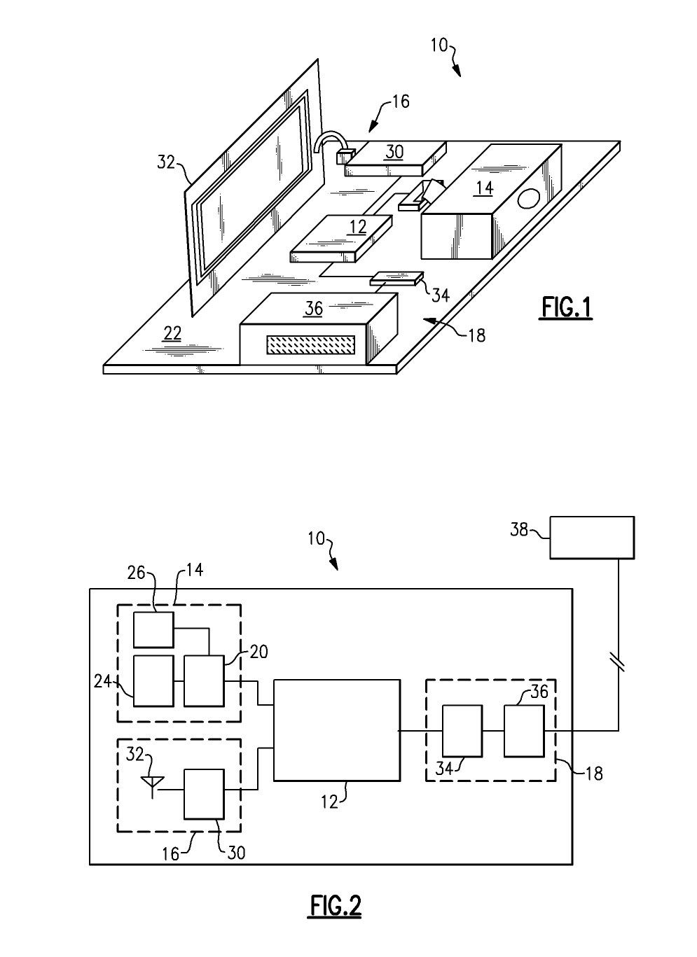

Referring now to the drawings, wherein like reference numerals refer to like parts throughout, there is seen in FIG. 1 an optical imaging and alignment system 10 according to the present invention. System 10 generally comprises a microcontroller 12 that is interconnected to a first optical imager 14 and/or an RFID unit 16 to a host interface 18. It should be recognized by those of skill in the art that RFID unit 16 is an optical feature not necessary to the present invention, but which may provide additional benefits. System 10 may be arranged on a single printed circuit board 22 and encased as a single unit or housing. Integration of imager 14 and RFID unit 16 through interface 18 allows for combining control of operation of both submodules, such as RFID reading and barcode, through system 10.

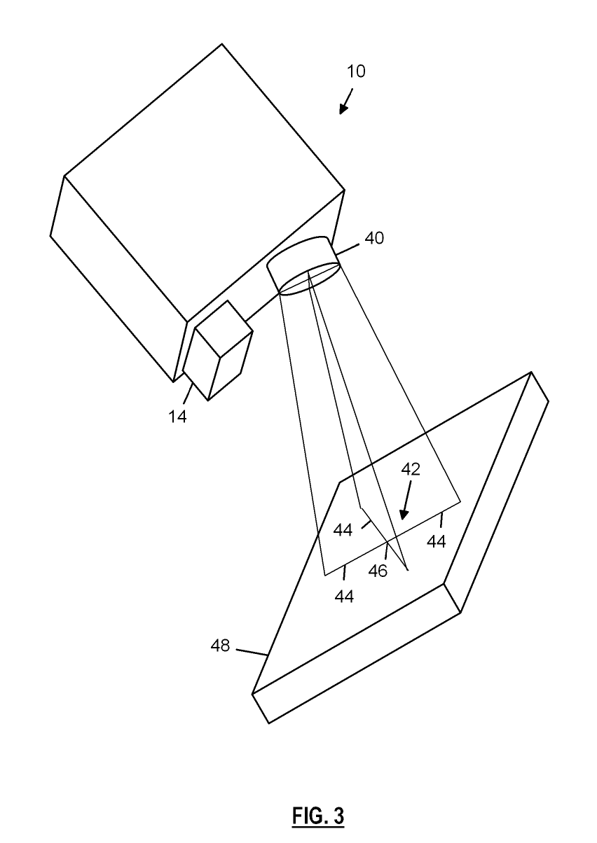

Referring to FIG. 2, optical imager 14 comprises an image engine 20 having image processing circuitry interconnected to microcontroller 12 for omni-directional optical scanning. Image engine 20 controls an image sensor 24, such as a complementary metal oxide semiconductor (CMOS) image sensor, and is capable of capturing two-dimensional images of ID linear barcodes, 2D stacked/matrix barcodes, standard optical character recognition (OCR) fonts, Reduced Space Symbology (RSS) barcodes, and postal barcodes, as well as providing image captured images for use in a wide range of applications, such as image and shape recognition, signature capture, image capture, and non-standard optical character recognition.

Imager 14 may comprise, but is not limited to, an IT4X10/80 SR/SF or IT5X10/80 series imager available from Hand Held Products, Inc. of Skaneateles Falls, N.Y. that is capable of scanning and decoding most standard barcodes including linear, stacked linear, matrix, OCR, and postal codes. Specifically, the IT5X10/80 series imager is a CMOS-based decoded output engines that can read 2D codes, and has image capture capabilities sufficient for use with system 10. Imager 14 obtains an optical image of the field of view and, using preprogrammed algorithms in image engine 20, deciphers the context of the image to determine the presence of any decodable barcodes, linear codes, matrix codes, and the like. Image engine 20 may be programmed to perform other image processing algorithms on the image captured by imager 14, such as shape recognition, match filtering, and other high-level processing techniques. Alternatively, a captured image may be processed by microprocessor 12, albeit with a decreased level of performance due to the additional communication time needed to transfer images from image engine 20 to microprocessor 12. Imager 14 further includes an illumination source 26, such as one or more light-emitting diodes (LEDs) of various wavelengths, i.e., colors. Those of skill in the art will instantly recognize that illumination source 26 may be provided as part of imager 14 or as a separate unit depending on the requirements of the particular application.

System 10 may optionally include RFID unit 16 including an RFID transceiver 30 and associated RFID antenna 32 supporting standard RFID protocols, such as the TI Tag-it transponder protocol or ISO 15693. For these protocols, transceiver 30 operates at 13.56 MHz, and may comprise a S6700 Multi-Protocol Transceiver IC available from Texas Instruments of Dallas, Tex. Depending on the application, other frequency transceivers may be more appropriate based on target range, power availability, cost, etc. RFID unit 16 may further include a speaker or LED (not shown) for audibly indicating a successful interrogation of an RFID tag.

Antenna 32 is preferably a loop antenna of various sizes and turns implemented on a printed circuit board and connected to system 10, or a wire loop installed antenna installed directly onto system 10. Antenna 32 may be positioned remotely, thereby reducing the footprint of system 10 using an external connector, such as a MMCX coaxial connector. RFID transceiver 30 may be programmed to interrogate passive or active tags, process signals received from such tags (e.g., analog to digital conversion), and provide the information from the tags to microcontroller 12 for further processing or transmittal to a host computer via interface 18.

Host interface 18 comprises a host transceiver 34 and a host connector 36 for interconnection to a host device 38. Interface 18 may comprise a conventional RS232 transceiver and associated 12 pin RJ style jack. For example, an ADM202EARN available from Analog Devices, Inc. of Norwood, Mass. is a suitable RS-232/V.28 interface device having compliant levels of electromagnetic emissions and immunity. Alternatively, interface 18 may comprise other conventional buses, such as USB, IEEE 1394, 12C, SPI, or PCMCIA, or other connector styles, such as an FFC style to an embedded host or another system 10. Interface 18 may also comprise a wireless transceiver in lieu of connector 36 for wireless communication to a host computer. A Stewart Connector Systems Inc. SS-641010S-A-NF may serve as connector 36 for mating with a Stewart Connector 937-SP-361010-031 matching connector of a host device. Host interface 18 may also comprise a Molex MX52588 connector. Regardless of the type of connector 36 used in connection with system 10, host transceiver 34 is programmed with the applicable protocols for interfacing with a host computer, such as USB, Bluetooth(r), and IrDA protocols. Transceiver 34 may also be programmed to support both non-inverted signal sense and inverted signal sense.

Microcontroller 12 comprises a conventional programmable microprocessor having on-chip peripherals, such as central processing unit, Flash EEPROM, RAM, asynchronous serial communications interface modules, serial peripheral interfaces, Inter-IC Buses, timer modules, pulse modulators with fault protection modules, pulse width modulators, analog-to-digital converters, and digital-to-analog converters. Additionally, the inclusion of a PLL circuit allows power consumption and performance to be adjusted to suit operational requirements. In addition to the I/O ports, dedicated I/O port bits may be provided. Microcontroller 12 may further include an on-chip bandgap based voltage regulator that generates an internal digital supply voltage from an external supply range. Microcontroller 12 preferably comprises a Motorola MC9S12E128.

The functional integration of imager 14 and RFID unit 16 to interface 18 is accomplished by microcontroller 12, which receives and interprets host commands, and then executes the appropriate functions by driving imager 14 and/or RFID unit 16 accordingly. For example, the operation of imager 14 and RFID unit 16 may be triggered by serial commands sent to system 10 from a host device 38, or by a hardware button communicating directly with connector 36 or through host device 38. Microcontroller 12 may further be programmed to execute the functions otherwise performed by one or more of image engine 20, RFID transceiver 30, and host transceiver 34, thereby reducing the amount of circuitry and hardware required by system 10.

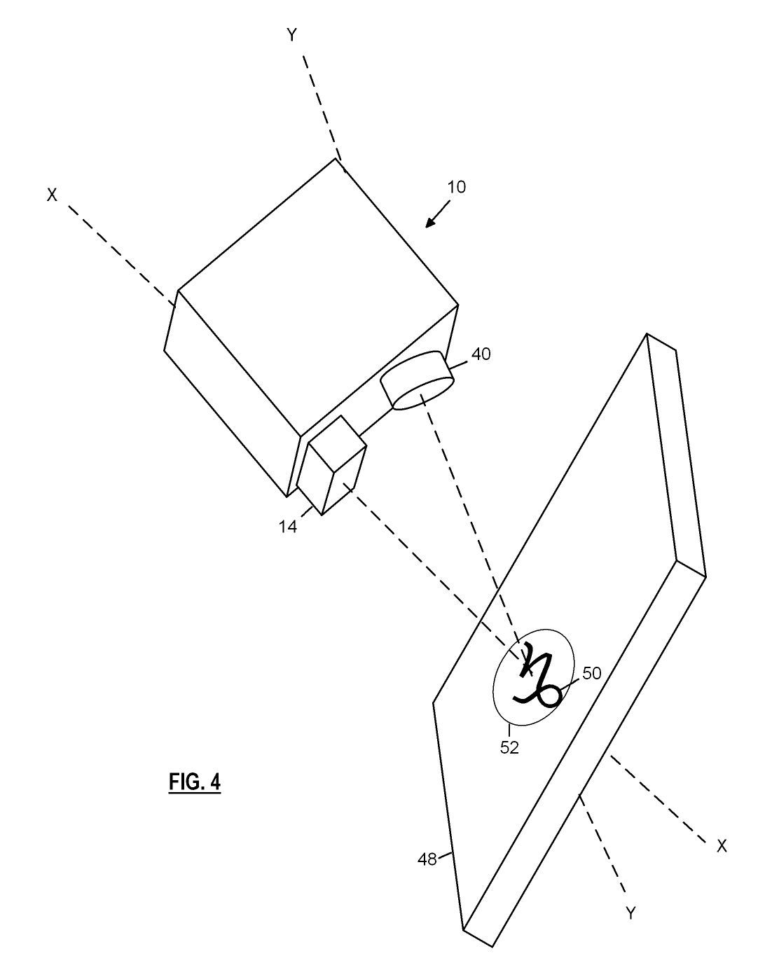

Referring to FIG. 3, system 10 further comprises an alignment laser assembly 40. Laser assembly 40 preferably comprises a laser diode and associated optics. For example, laser assembly 40 may comprise a LM-761-A1 laser module available from Excel Scientech Co., Ltd. of Taiwan, R.O.C., such as that provided with some model imagers 14. Laser assembly 40 is preferably configured to project a targeting image 42 having four segments 44 extending outwardly from a common point 46. Preferably, segments 44 of targeting image 42 produced by laser assembly 40 are configured to be of equal length and be at right angles to each other, thereby forming cross-hairs when targeting image 42 encounters a planar surface 48, such as a piece of paper. In addition, each segment 44 preferably has predetermined length when imager 14 is positioned at an optimum distance from surface 48 for capturing images thereof. It should be recognized by those of skill in the art that segments 44 may comprise solid lines, or lines formed from a series of dots using masking techniques.

Laser assembly 40 is also configured to produce segments 44 having a predetermined relationship to a target 50 to be imaged and decoded, such as a barcode, symbol, or encoded icon, when imager 14 is positioned at a desired distance from surface 48. Laser assembly is preferably triggered by a user prior to triggering an image capture by imager 14. Fox example, when imager 14 is provided in a handheld unit that is manually activated, such as by a manual trigger or button, manual activation first activates laser assembly 40. Imager 14 captures an optical image of target 50 after a predetermined delay or further manual triggering by the user. For example, manual activation may comprise the actuation of a two-stage manual trigger that, when partially activated, triggers laser assembly 40 and, when fully activated, triggers imager 14 to capture an image. Alternatively, separate triggers may be provided for laser assembly 40 and imager 14. Preferably, a hardware trigger actuated by a user results in software commands that first activates laser assembly 40 to provide aiming for a short, predetermined time period, and then activates decoding of geometric FIG. 52. Thus, decoding is delayed for a short time to allow for proper orientation of the device.

As seen in FIG. 6, imager 14 is generally aligned along axis X-X and laser assembly 40 is aligned on non-parallel axis Y-Y for projecting targeting image 42 onto target 50, which is also within the image capture field of imager 14. In the example above, the optimum focal distance is four inches, with laser assembly 40 configured accordingly.

Targeting image 42 may also be used to determine the proper distance of imager 14 from target 50. For example, as seen in FIG. 5, the length of segments 44 of targeting image 42 relative to optimum image capturing distance may be configured such that segments 44 fit exactly within geometric FIG. 52 when imager 14 is the appropriate distance from target 50. Thus, a user may view targeting image 42 and then move imager 14 closer or farther from target 50 depending on whether the segments extend beyond geometric FIG. 52 or do not reach the perimeter of geometric FIG. 52, respectively.

Referring to FIG. 5, system 10 further comprises the positioning of a geometric FIG. 52, such a circle, around target 50 to be imaged. When a user directs imager 14 at target 50, laser assembly 40 is triggered to emit targeting image 42 onto target 50 in a predetermined relationship to geometric FIG. 52. As seen in FIG. 5, a preferred embodiment of the present invention comprises targeting image 42 as cross-hairs that are configured to fit exactly within geometric FIG. 52, which comprises a circle formed around target 50.

Based on the relationship between targeting image 42, target 50, and geometric FIG. 52, a user may verify that imager 14 is properly aligned to capture an image of target 50 that will optimize successful decoding of information encoded into target 50. In the event that imager 14 is not properly aligned, a user may easily determine the best and fastest way to align imager 14 for example a successful image capture by viewing the relationship between targeting image 42, target 50, and geometric FIG. 52. For example, as seen in FIG. 6, the presence of unequal length segments in targeting image 42 reveal that imager 14 is tilted too far in one direction from the ideal axis X-X for proper imaging alignment and a successful read. By viewing targeting image 42 as imager 14 is realigned, a user may quickly and easily adjust imager 14 to obtain the proper location and alignment of axis X-X relative to target 50.

Targeting image 42 may comprise other shapes, such as circle having the same dimension as geometric FIG. 52, thereby allowing a user to properly align imager 14 by superimposing targeting image 42 onto geometric FIG. 52. It should thus be recognized by those of skill in the art that any combination of shapes may be used, provided that targeting image 42 and geometric FIG. 52 are interrelated such that a user can determine the proper distance for positioning imager 14 and alignment of imager 14 relative to axis X-X.

What is claimed is:

1. An system for capturing an optical image of a target, comprising:
an optical imager aligned along a first axis;
a laser assembly aligned along a second axis; and
wherein said laser assembly is configured to project an image having a predetermined relationship to said target.

2. The system of claim 1, wherein said first axis and said second axis are non-parallel.

3. The system of claim 2, wherein said image of said laser assembly is configured to fit within a predetermined portion of said target when said imager is properly aligned to capture an image of said target.

4. The system of claim 3, wherein said image comprises four segments extending from a common point.

5. The system of claim 4, wherein said target comprises a symbol containing encoded information surrounded by a geometric shape.

6. The system of claim 5, wherein said geometric shape is a circle.

7. The system of claim 6, wherein each of said segments extends at right angles to each adjacent segment and all of said segments are of equal length.

8. The system of claim 7, wherein said segments are configured to fit within said circle when said image is positioned at a predetermined distance from said target.

9. A method of improving imaging of a target containing encoded information, comprising the steps of:
directing an optical imager at said target;
projecting a targeting image onto said target;
aligning said imager based on the relationship between said targeting image and said target; and
capturing an image of said target; and
decoding information contained in said image.

10. The method of claim 9, wherein said targeting image is configured to fit within a predetermined portion of said target when said imager is properly positioned to capture an image of said target.

11. The method of claim 10, wherein said targeting image comprises four segments extending from a common point.

12. The method of claim 11, wherein said target comprises a symbol containing encoded information surrounded by a geometric shape.

13. The method of claim 12, wherein said geometric shape is a circle.

14. The method of claim 13, wherein each of said segments extends at right angles to each adjacent segment and all of said segments are of equal length.

15. The method of claim 14, wherein said segments are configured to fit within said circle when said image is positioned at a predermined distance from said target.
